(19) United States
(12) Patent Application Publication
(10) Pub. No.: US 2007/0283504 A1
(43) Pub. Date: Dec. 13, 2007

(54) Machine for processing animal hides

(76) Inventor: Ronald Eugene Wegner, Milton, WI (US)

Correspondence Address: Ronald Eugene Wegner, 2214 East Manogue Road, Milton, WI, 53563, US

(21) Appl. No.: 11/451,573

(22) Filed: Jun. 13, 2006

(51) Int. Cl. C14C 3/00

(52) U.S. Cl. 8/94.19 R

(57) ABSTRACT

A machine and method for processing animal hides with a vessel to hold animal hides, processing animal hides in a closed container held under vacuum, rotating a container allowing for the repeated emersion of the animal hides, paddles within the container which move a hide through a tanning solution, paddles within the container aligned to minimize the damage to the hides by abrasion, a process of tanning using a vacuum which eliminates the need for heating the tanning solution, and a process of tanning using a vacuum which reduces the time necessary to prepare animal hides. A preferred embodiment includes a vessel made of materials resistant to the corrosive action of the tanning solution.

### BACKGROUND OF THE INVENTION

This invention relates generally to the field of Taxidermy and more specifically to a machine and process for processing animal hides. The present invention relates to a machine and process for treating animal hides. In particular, the invention relates to a process for hide used for taxidermy.

One familiar to the art of taxidermy and tanning process recognize the most intrinsic value of animal skins is the fur or hair. This process will only consider tanning of skins with intact hair or fur. This is the key to the art of taxidermy. The tanning process usually includes a series of steps, whose execution requires considerable time. Tanning is a process for preparing and treatment of the hide to remove impurities and fat.

The process of tanning starts with the removal from the skin of fat and muscle; minimizing the amount skin removed with the fat and muscle. The hide is washed to remove blood and loose dirt. Next, the skin is fleshed to remove fat and muscle by scraping the hide clean. The hide is cured to temporarily preserve the skin until tanning can be commenced. This curing can be salting, drying or other chemical treatments. To avoid putrefaction and loosening of hair the curing step should be complete soon after the skinning process. After curing the hide is washed again and then scoured to remove of dirt and natural grease from the hair or fur. Pickling of the hide with a bath of chemical commonly salt/acid mixture. The skins may soak for days during this step.

After pickling the hides are tanned. Tanning is only one step in the overall conversion of raw skins to finished leather, although the whole process is generally referred to as “tanning”. This is essentially the chemical conversion of raw skin from a form easily damaged by bacteria and heat, to a form which is stable to heat, bacteria and washing. After tanning and fatliquoring the skin will dry to a soft flexible form which we know as leather. Agitation of the hide is important during the tanning process.

Because of the ease of use and the stability of the final products, chromium sulphate tanning is common, even though there are many other chemicals capable of tanning skins. The previous treatments are usually performed in special drums, with appropriate liquid substances. The various solutions are reserved to be used over, thus, reducing the contribution to environmental pollution. The drums used in the tanning process were previously left to interact with the air. The interaction results in the production of fumes and dilution of the tanning solutions. The previous art is also a time consuming process. Previous art requires the hide to be agitated within the drum. This agitation can cause lose of hair or fur on the specimen.

### BRIEF SUMMARY OF THE INVENTION

The primary object of the invention is to provide a machine for the efficient means of treating animal hides. Another object of the invention is to provide a machine to repeatedly immerse animal hides during the process of tanning. The invention provides a method for efficient application of tanning solution to animal hides. The invention makes use of a container to hold the tanning solution an animal hides. The container is maintained under vacuum to efficiently apply the tanning solution to an animal hide. The invention provides a method of maintaining a vacuum during the tanning process. The vacuum is sustained while the container is rotated along its central axis. The container used as part of the invention has a unique paddle system used to threat an animal hide. As the container is rotated during the tanning process the paddle's unique arrangement and construction allows for an aggressive and efficient application of the tanning solutions. The paddles unique arrangement also minimizes damage by the tanning process to the animal's hides, which other tanning systems lack. The invention's method for using vacuum and rotation eliminates the need to heating the tanning solution. Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a machine and process for processing animal hides comprising: a vessel to hold animal hides, processing animal hides in a closed container held under vacuum, rotating a container allowing for the repeated emersion of the animal hides, paddles within the container which move a hide through a tanning solution, paddles within the container aligned to minimize the damage to the hides by abrasion, a process of tanning using a vacuum which eliminates the need for heating the tanning solution, and a process of tanning using a vacuum which reduces the time necessary for the tanning of animal hides.

### BREIF DESCRIPTION OF THE DRAWINGS

FIG. 1 is a plane view of the invention's vessel.

FIG. 2 is a plane view of the cover of the invention's vessel.

FIG. 3 is a cross sectional view of the invention along the line A-A.

FIG. 4 is a plane view of the invention veiwed from the top.

FIG. 5 is a plane view of the invention.

The drawings constitute a part of this specification and include exemplary embodiments to the invention, which may emerge in various forms. It is to be understood that in some instances various aspects of the invention may be shown exaggerated or enlarged to facilitate an understanding of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The invention is a machine used for tanning animal hides used for taxidermy. Those familiar with the art of taxidermy recognize that is a great deal of time required to activate the tanning solution and the animal hides. Prior art required prolonged emersion of the animal hides in the tanning fluid and manual agitation. As a means to reduce the time required the tanning solution was heated. Because the toxic nature the tanning fluid the fumes caused by the heated solution require additional treatment after use. By processing the animal hides under vacuum the time required is reduced. The tanning process is further reduced; this is accomplished in the present instance by rotating the tank, hides and tanning solutions. Using a vacuum eliminates the need for heating the tanning solution as a means of speeding up the tanning process.

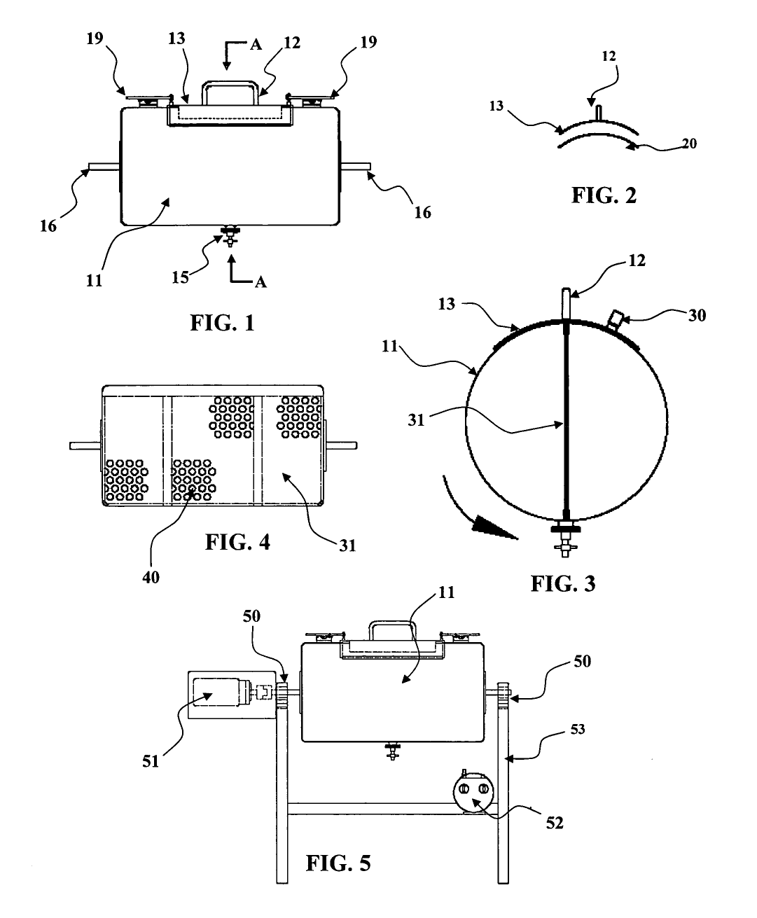

The invention is a machine used to tanning animal hides for taxidermy. Turning first to FIG. 1 there is shown a vessel item 11 of FIG. 1 consisting of and a cover item 13 of FIG. 1. In accordance with one of the main features of the invention the vessel is used to hold the animal hides and the tanning solution. A means is provided for to create a vacuum within the tank. In accordance with a further aspect of the invention the vessel is rotated, while under vacuum. Due to the corrosive nature of the tanning solutions the tank item 11 in FIG. 1 is made of materials resistance to the corrosive action. In the preferred embodiment of the invention the material used for construction of the vessel item 11 in FIG. 1 maybe, but not limited to stainless steel construction.

The vessel FIG. 1 item 11 is constructed to maintain a vacuum. Access to the vessel is gained by means of the sealed cover item 13 in FIG. 1. A handle item 12 in FIG. 1 is used to remove the cover from the tank. Latches item 19 in FIG. 1 are shown as a means to secure the cover item 11 in FIG. 1 to keep the cover secure if there was a loss of the seal and or vacuum. In accordance with a further aspect of the invention the support of the vessel by the shafts items 16 in FIG. 1 allows for the free rotation of vessel in a circular movement. In an alternative embodiment of the invention the shafts could mounted off axis, causing the vessel to have an eccentric movement.

A valve item 30 in FIG. 3, allows for the venting and vacuum connection. The valve item 30 in FIG. 3 is connected to a vacuum pump. Once the proper vacuum is achieved the valve item 30 in FIG. 3 is closed and the connection to the vacuum pump removed. The petcock valve item 15 in FIG. 1 is used to drain the tanning solution.

Examining FIG. 2 the cover item 13 of the vessel item 11 FIG. 1 is shown. An important function of the invention is accomplished, with the gasket item 20 in FIG. 2, used to maintain a seal for the vacuum.

In accordance with the present invention, FIG. 3 shows detail of cross section A-A. Shown in FIG. 3 item 11 is the vessel consisting of the cover item 13 of FIG. 3, and a petcock valve item 15 used to drain the vessel item 11 in FIG. 3 of the tanning solution. Due to the corrosive nature of the tanning solutions the vessel item 11 of FIG. 3 is made of materials resistance to the corrosion. This material maybe but not limited to stainless steel construction. A handle item 13 in FIG. 3 is used to remove or place the cover on the vessel item 11 of FIG. 3. The valve item 30 of FIG. 3 is for venting and connection to a vacuum pump. After achieving the desired vacuum the valve item 30 of FIG. 3 is closed and the vacuum connection removed.

The vessel item 11 of FIG. 1 will be free to rotate in a circular motion along the axis and supported by FIG. 1 item 16. As the container is rotated the dividers FIG. 3 item 31 causes the hides to be repeatedly moved through the tanning solution. To accomplish an important function of the invention, there is shown a perforated divider FIG. 3 item 31. The dividers FIG. 3 item 31 allows for the agitation of the hides while moving through the tanning solution. The dividers FIG. 3 item 31 may be are arranged in various ways without departing from the invention and the function of dividers. Due to the corrosive nature of the tanning solutions the dividers FIG. 3 item 31 is made of materials resistance to the corrosion. This material maybe but not limited to stainless steel construction.

Turning now to FIG. 4 illustrates a plane view of the vessel FIG. 1 item 11 from the top. In a preferred embodiment of the invention the perforations in the dividers FIG. 4 item 40 would be circular and arranged in a uniform pattern. In alternative embodiment the perforation's shape and pattern would be changed to maximize the agitation of the animal hides while, minimizing the any damage to the animal hides due to abrasion. The dividers FIG. 4 item 4 are secured or fastened within the vessel items 11 in FIG. 1.

Turning now to FIG. 5 shows a plane view of the invention. Item 53 in FIG. 5 illustrates the frame which is intended to support the vessel FIG. 5 item 11. In accordance with a further aspect of the invention the support of the vessel item 11 in FIG. 5 by the shafts items 16 in FIG. 1 allows for the free rotation of vessel in a circular movement. Bearing surfaces FIG. 5 item 50 allow free movement of the shafts items 16 in FIG. 1. To accomplish an important function of the invention, there is shown item 51 in FIG. 5 a drive unit. The drive unit 51 in FIG. 5 is attached, or connected to 16 in FIG. 1 in a manner which causes the shaft 16 in FIG. 1 and vessel item 11 to rotate. The speed of rotation can be controlled by the drive unit item 51 in FIG. 5. The drive unit 51 in FIG. 5 includes controls starting and stopping of rotation of the vessel item 11. A vacuum pump item 52 is used to evacuate the vessel item 11 of FIG. 3. The valve item 30 FIG. 3, provides a means of connection and control for the vacuum pump item 52 of FIG. 5.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. In accordance with a preferred embodiment of the invention, there is disclosed a machine and process for processing animal hides comprising: a vessel to hold animal hides, processing animal hides in a closed container held under vacuum, rotating a container allowing for the repeated emersion of the animal hides, paddles within the container which move a hide through a tanning solution, paddles within the container aligned to minimize the damage to the hides by abrasion, a process of tanning using a vacuum which eliminates the need for heating the tanning solution, and a process of tanning using a vacuum which reduces the time necessary for the tanning of animal hides.

2. In accordance with a preferred embodiment of the invention, there is disclosed the invention as claimed in claim 1 wherein said vessel are made of materials resistant to the corrosive action of the tanning solution.

3. An article of manufacture for a machine and method of processing animal hides as claimed in 2 said the vessel is rotated along the vessel's axis providing uniform emersion of the animal hides.

4. An article of manufacture for a machine and method of processing animal hides as claimed in 2 said vessel comprising paddles so that the tanning solution uniformly and aggressively applied to the animal hides.

5. An article of manufacture for a machine and method of processing animal hides as claimed in 4 further comprising a novel arrangement of said paddles wherein damage is minimize to animal hides.
